(19) United States
(12) Patent Application Publication
(10) Pub. No.: US 2014/0052541 A1
(43) Pub. Date: Feb. 20, 2014

(54) METHOD AND APPARATUS FOR PROVIDING AN ADVERTISEMENT ON AN IMAGE TRANSLATION DEVICE

(71) Applicant: Marvell World Trade Ltd., St. Michael (BB)

(72) Inventor: Patrick A. McKinley, Corvallis, OR (US)

(73) Assignee: Marvell World Trade Ltd., St. Michael (BB)

(21) Appl. No.: 13/965,358

(22) Filed: Aug. 13, 2013

Related U.S. Application Data
(60) Provisional application No. 61/684,589, filed on Aug. 17, 2012.

(51) Int. Cl. G06Q 30/02

(52) U.S. Cl. CPC G06Q 30/0269
USPC 705/14.66

(57) ABSTRACT

Some of the embodiments of the present disclosure provide a method comprising performing, by a peripheral device, an image translation operation on an image; in response to performing the image translation operation on the image, detecting, by the peripheral device, an attribute associated with the image; transmitting, by the peripheral device, the attribute to a server over a network; in response to transmitting the attribute to the server over the network, receiving, by the peripheral device, an advertisement that is generated based on the attribute; and providing, by the peripheral device, the advertisement to a user of the peripheral device.

### CROSS REFERENCE TO RELATED APPLICATIONS

This claims priority to U.S. Provisional Patent Application No. 61/684,589 filed on Aug. 17, 2012, which is incorporated herein by reference.

### TECHNICAL FIELD

Embodiments relate to image translation devices, and more particularly, to techniques for providing an advertisement on an image translation device.

### BACKGROUND

Oftentimes, suppliers of image translations devices—for example, printers, scanners, and multi-function printers—choose to sell such devices at relatively less or no profit, and rely on a steady stream of consumable products (e.g., ink or toner) for profit. These suppliers aim to increase their profit margin by generating new streams of revenue.

### SUMMARY

In various embodiments, the present disclosure provides a method comprising performing, by a peripheral device, an image translation operation on an image; in response to performing the image translation operation on the image, detecting, by the peripheral device, an attribute associated with the image; transmitting, by the peripheral device, the attribute to a server over a network; in response to transmitting the attribute to the server over the network, receiving, by the peripheral device, an advertisement that is generated based on the attribute; and providing, by the peripheral device, the advertisement to a user of the peripheral device.

In various embodiments, the present disclosure provides a peripheral device comprising an image translation module configured to perform an image translation operation on an image; a keyword module configured to, in response to the image translation operation being performed on the image, (i) detect an attribute associated with the image and (ii) transmit the attribute to a server over a network; an advertisement reception module configured to, in response to the attribute being transmitted to the server over the network, receive an advertisement that is generated based on the attribute; and an advertisement providing module configured to provide the advertisement to a user of the peripheral device.

### BRIEF DESCRIPTION OF THE DRAWINGS

In the following detailed description, reference is made to the accompanying drawings which form a part hereof wherein like numerals designate like parts throughout, and in which is shown by way of embodiments that illustrate principles of the present disclosure.

FIG. 1 schematically illustrates a system comprising a peripheral device configured to provide an advertisement to a user.

FIG. 2 schematically illustrates the peripheral device of FIG. 1 in more details.

FIG. 3 illustrates an example method for providing an advertisement to a user via a peripheral device.

### DETAILED DESCRIPTION

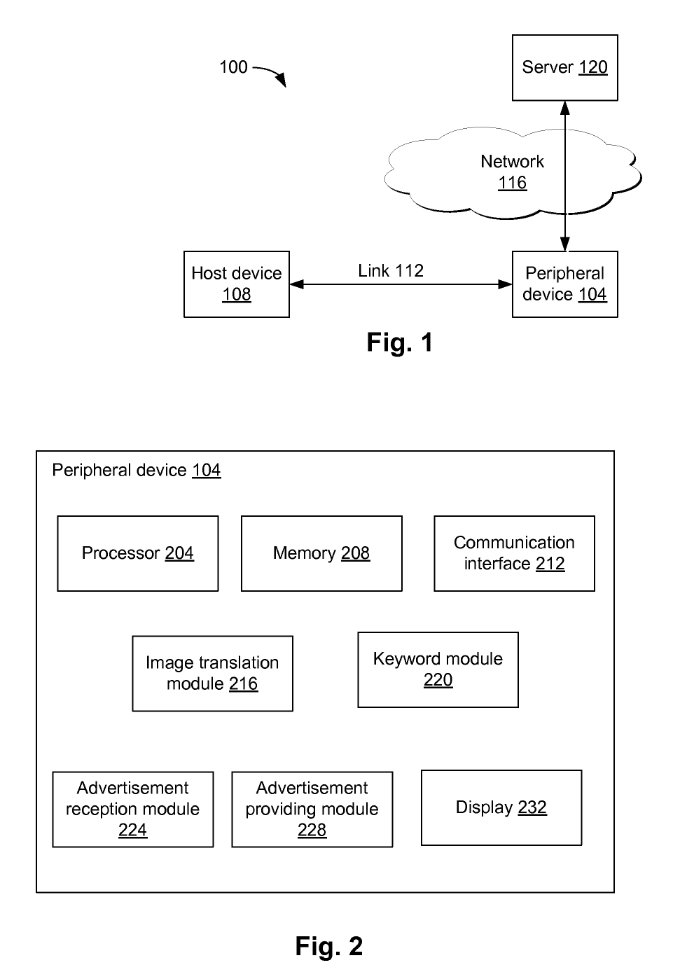

FIG. 1 schematically illustrates a system 100 comprising a peripheral device 104 configured to provide an advertisement to a user. In an embodiment, an advertisement provided to a user can be an advertisement specifically targeted to the user based on one or more attributes as described in greater detail below. An advertisement that is specifically targeted to a user is referred to herein as a “targeted advertisement”. In an embodiment, the peripheral device 104 is coupled to a host device 112 over a communication link 108 (henceforth referred to as “link 108”). The host device 104 is, for example, a personal computer, a desktop, a laptop, a tablet computer, a smart phone, a mobile phone, a handheld device, and/or any consumer electronic device capable of interfacing with a peripheral device. Although the peripheral device 104 is illustrated in FIG. 1 as communicating with only one host device, in an embodiment, the peripheral device 104 may communicate with more than one host device.

In an embodiment, the peripheral device 104 is an image translation device configured to perform image translation operations. For example, the peripheral device 104 may be a printing device, a scanning device, a copying device, a faxing device, a combination of one or more of these devices, a multi-function printer (MFP), or the like.

Image translation operation, as used herein, refers to a translation of an image that exists in a particular context (e.g., medium) into an image in another context. For example, an image translation operation may be a scan operation. For scanning operations, a target image, e.g., an image that exists on a tangible medium (e.g., a paper), is scanned by the peripheral device 104 and an acquired image that corresponds to the target image is created and stored in a memory of the peripheral device 104 (e.g., for subsequent transmission to the host 108 over the link 112). In another example, an image translation operation may be a print operation. In this situation, an acquired image, e.g., an image as it exists in memory of the peripheral device 104 (e.g., which is received by the peripheral device 104 from the host 108), may be printed onto an adjacent medium (e.g., a paper). In yet another example, an image translation operation may be a copying operation, a faxing operation, or the like.

An image (which is associated with the image translation operation performed by the peripheral device 104) may refer to, for example, a picture, a drawing, a map, a document containing text, a combination of one or more of these, and/or the like. Thus, an image may refer to something that can be translated during an image translation operation by the peripheral device 104.

The peripheral device 104 is coupled to the host device 108 over the link 112. The link 112 may be any appropriate type of link, e.g., a wired communication link (e.g., an Ethernet link, a Universal Serial Link (USB), etc.) and/or a wireless communication link. The host 108, for example, transmits an image for printing by the peripheral device 104 via the link 112, receives a scanned image from the peripheral device 104 via the link 112, and/or the like.

In an embodiment, the peripheral device 104 is configured to communicate with a server 120 over a network 116. The network 116 is, for example, the Internet, a local area network, a wide area network, and/or the like. The server 120 is associated with, for example, a website that generates and/or provides advertisements based on one or more keywords. Merely as an example, the website may provide search functionality (e.g., Google®, Yahoo®, Bing®, and/or the like), and generate advertisements based on one or more keywords. In another example, the website may be a website that specifically generates advertisement, based on one or more keywords.

Although FIG. 1 illustrates only one server 120, in an embodiment, the server 120 may represent a plurality of servers associated with a single website. Although not illustrated in FIG. 1, in an embodiment, the peripheral device 104 may communication with a plurality of servers associated with a corresponding plurality of search/advertisement websites.

In an embodiment and as will be discussed in more detail herein later, the peripheral device 104 performs an image translation operation on a document. In response to performing the image translation operation on the document, the peripheral device 104 detects one or more attributes (e.g., keywords, phrases, names, symbols, logos, or the like) associated with the document. In an example, the peripheral device 104 may extract words or phrases from a document (or from metadata associated with the document) that is printed, scanned, copied and/or faxed by the peripheral device 104, to detect attributes (e.g., keywords) associated with the document. Keywords, for example, are search terms (e.g., words, phrases, or the like) that the peripheral device 104 detects and transmits to the server. The server 120 generates an advertisement (e.g., a targeted advertisement), based on the received keywords, and transmits the advertisement to the peripheral device 104. The peripheral device 104 provides the advertisement to a user of the peripheral device 104 (e.g., displays the advertisement on a display of the peripheral device 104, prints the advertisement, transmits the advertisement to the host device 108 for displaying on a display of the host device 108, etc.).

FIG. 2 schematically illustrates the peripheral device 104 of FIG. 1 in more details. In an embodiment, the peripheral device 104 comprises a processor 204, a memory 208 and a display 232. The processor 208 includes one or more processors configured to execute instructions. The instructions are stored in the memory 208. The display 232 is configured to display information associated with the operation of the peripheral device 104, as well as display advertisements received by the peripheral device 104 from the server 120. The peripheral device 104 further comprises a communication interface 212 configured to facilitate communication with the host 108 and/or the server 120.

The peripheral device 104 comprises a plurality of other modules. As used herein, the term “module” may refer to, be part of, or include an Application Specific Integrated Circuit (ASIC), an electronic circuit, a processor (shared, dedicated, or group, e.g., the processor 204) and/or memory (shared, dedicated, or group, e.g., the memory 208) that execute one or more software or firmware programs, a combinational logic circuit, and/or other suitable components that provide a described functionality.

The peripheral device 104 comprises an image translation module 216. The image translation module 216 is configured to perform an image translation operation, e.g., a printing operation, a scanning operation, a copying operation, a faxing operation, or a combination of one or more of these operations.

In an embodiment, the peripheral device 104 comprises a keyword module 220 configured to detect one or more keywords associated with an image that is translated by the image translation module 216. In an example, the keyword module 220 monitors files (e.g., which includes images for printing by the peripheral device 104) downloaded from the host device 108 to the peripheral device 104 for printing. In an example, the files downloaded to the peripheral device 104 include metadata associated with the files. While the peripheral device 104 is initially coupled to the host device 108, a device driver of the peripheral device 104 is installed in the host device 108. In an embodiment, the keyword module 220 requests metadata associated with the files (e.g., files that are transmitted from the host device 108 to the peripheral device 104 for printing) from the device driver installed in the host device 108. In an embodiment, the device driver installed in the host device 108 is configured such that whenever the host device 108 transmits a file to the peripheral device 104 for printing, the device driver facilitates transmission of metadata associated with the file from the host device 108 to the peripheral device 104.

The keyword module 220, thus, has access to a file to be printed and/or metadata associated with the file. In an example, the keyword module 220 extracts file properties, file name, date, an author, description, title, etc. from the file, or the associated metadata. In another example, if the file to be printed includes text, the keyword module 220 reviews the text to identify keywords from the text. In another example, if the file to be printed includes an image (e.g., a picture in JPEG format), the keyword module 220 detects various properties (e.g., Exchangeable image file format (Exif) properties) associated with the file, e.g., detects geolocation information of the captured picture, capture date/time, file name, title, captions, etc. associated with the file, and identifies one or more keywords associated with the file.

As an example, the peripheral device receives a file for printing, where the text included in the file (or metadata associated with the file) indicates that the file is associated with a cure for arthritis. For example, the text of the file may include the words “arthritis” and “cure” at least a threshold number of times. Accordingly, the keyword module 220 may detect the word “arthritis” as a keyword. In another example, the peripheral device receives a file for printing, where the file includes a coupon for a specific brand of breakfast cereal. Accordingly, the keyword module 220 may detect “cereal” as a keyword.

In another example, while the peripheral device 104 is used for scanning, copying and/or faxing an image, the keyword module 220 performs an optical character recognition on the image to identify text included in the image. From the text included in the image, the keyword module 220 detects keywords associated with the image.

In another example, the keyword module 220 obtains information associated with a user of the peripheral device 104. Such information includes, for example, personalization data associated with the user, a geolocation of the user (e.g., from an Internet Protocol (IP) address associated with the peripheral device 104), a historical printing/scanning/copying/faxing habit of the user, a lists of websites from which the user downloads and prints files, etc. Such personalization information of the user may also be used by the keyword module 220 to generate keywords.

In yet another example, the device driver of the peripheral device 104 that is installed in the host device 108 may also transmit information to the keyword module 220 to generate keywords (or may transmit the keywords to the keyword module 220). For example, the device driver (or another appropriate program (e.g., a web browser) installed in the host device 104, with which the device driver communicates) may keep track of the websites visited by the user from the host device 104 (and/or may keep track of purchases made online using the host device 108), and transmit such information to the peripheral device 108 to enable the keyword module 220 to generate keywords.

In an embodiment, based on detecting the keywords, the keyword module 220 transmits (e.g., using the communication interface 212) the detected keywords to the server 120 via the network 116. The server 120 generates one or more advertisements, based on the received keywords. For example, if the keywords are “arthritis” and “cure,” the server 120 may generate one or more advertisements directed to medicines used for treating arthritis, a local clinic (e.g., which is located in the same geolocation as the user of the peripheral device) that specializes in treating arthritis, etc. In another example, if the keywords are “breakfast cereal”, the server 120 may generate one or more advertisements directed to cereals from various manufacturers, other food items, one or more stores that sell breakfast cereals, and/or the like. The server 120 transmits the one or more advertisements to the peripheral device 104 over the network 116.

In an embodiment, one more attributes of the peripheral device 104 is also transmitted by the keyword module 220 to the server 120. For example, a size of the display 232 of the peripheral device 104 is transmitted to the server 120, to enable the server 120 to select or format an advertisement that can be effectively displayed in the display 232 of the peripheral device 104.

The peripheral device 104 also comprises an advertisement reception module 224 configured to receive the advertisements transmitted by the server 120 to the peripheral device 104. In an embodiment, the received advertisements are temporarily stored in the memory 208 of the peripheral device 10 (and/or in a memory of the host device 108).

The peripheral device 104 also comprises an advertisement providing module 228 configured to provide the advertisements, received by the advertisement reception module 224, to a user of the peripheral device 104. In an example, providing the advertisements to the user of the peripheral device 104 comprises displaying the advertisements on the display 232 of the peripheral device and/or printing the advertisement. For example, based on the keyword being “arthritis,” the peripheral device 104 displays an advertisement of a medicine for arthritis or a local clinic that specializes in treating arthritis, and/or prints a coupon for the medicine for arthritis. In an embodiment, the advertisements can be displayed on the display 232 prior to, concurrently with, and/or subsequent to the peripheral device 104 performing an image translation operation. In an embodiment, the advertisements can be displayed on the display 232 while the peripheral device 104 is idle (i.e., not actively engaged in an image translation operation). In an embodiment, if multiple advertisements are to be displayed on the display 232, the advertisements may be displayed as a slide show on the display 232. In an embodiment, the peripheral device 104 is configured to periodically or continuously display advertisements (e.g., whenever the peripheral device 104 is not in a sleep mode or a low power mode).

In another example, providing the advertisements to the user of the peripheral device 104 comprises transmitting, by the peripheral device 104, the advertisements to the host device 108, to enable the host device 104 to display the advertisements. For example, the device driver installed in the host device 108 can be configured such that the device driver receives the advertisements from the peripheral device 104, and displays the advertisements on a display of the host device 108.

In an embodiment, an advertisement displayed on the display 232 is interactive in nature. That is, the advertisement can interact with a user of the peripheral device 104. For example, the advertisement can display options to print a coupon associated with the advertisement, provide more information about a product, and/or the like.

The user can, for example, using buttons of a control panel of the peripheral device 1104, select an option associated with the advertisement. In an embodiment, the advertisement providing module 228 monitors the control panel for user interaction to potentially respond to an advertisement. For example, upon the user selecting an option to print a coupon associated with the advertisement, the peripheral device 104 downloads the coupon from the server 120, and prints the coupon.

In another example, upon selection of an option to provide more information about a product, the peripheral device 104 downloads additional information about the product from the server 120 (or from another server that hosts a webpage associated with the product) and displays the additional information. In yet another example, upon selection of the option to provide more information about the product, the peripheral device 104 displays a link to a webpage that includes the additional information, and/or transmits the link to the host device 108.

In an embodiment, revenue is generated in response to the peripheral device 104 providing advertisements to the user. The generated advertisement based revenue depends, for example, on a number of advertisements provided by the peripheral device 104, a number of times a user interacted with the advertisements (i.e., a number of responses generated from the advertisements), nature of the advertisements (e.g., directed towards high priced products or low priced products), the ability of the keyword module 220 to provide unique search terms or keywords for targeting advertisements from specific sponsors, and/or the like.

In an embodiment, the advertisement based revenue is, for example, directed to an owner of the peripheral device 104, a manufacturer of the peripheral device 104, a seller of the peripheral device 104, a developer who develops the modules necessary to provide advertisements in the peripheral device 104, a combination of one or more of these stakeholders, and/or the like. For example, the revenue may be directed in accordance with an agreement between these stakeholders, and/or in accordance with a configuration of the peripheral device 104.

The system 100 of FIG. 1 provides an enhanced business model for peripheral devices, by providing a source of revenue to the stakeholders (e.g., the owner, manufacturer and/or the seller of the peripheral device 104). The system 100 provides a new advertising platform. In an embodiment, as the manufacturer and/or the seller of the peripheral device 104 potentially earns revenue through advertisements in the peripheral device 104, a sale of the peripheral device 104 may be subsidized, thereby bringing down a cost of the peripheral device 104.

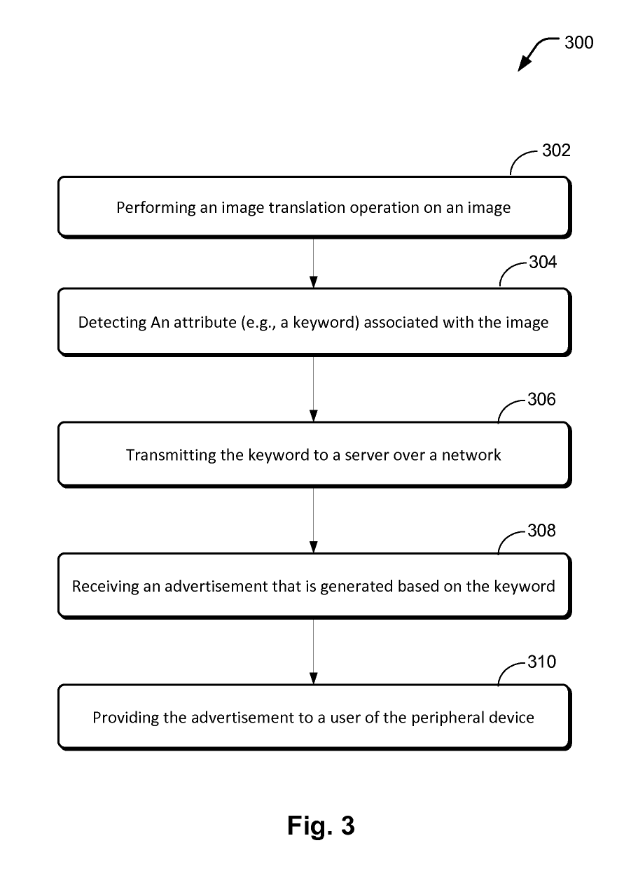

FIG. 3 illustrates an example method 300 for providing an advertisement to a user via a peripheral device (e.g., the peripheral device 104 of FIG. 1). At 302, a peripheral device (e.g., the peripheral device 104 of FIG. 1) performs an image translation operation on an image (e.g., prints, scans, copies, or faxes the image).

At 304, in response to performing the image translation operation on the image, the peripheral device (e.g., the keyword module 220 of the peripheral device 104) detects an attribute, e.g., a keyword associated with the image. For example, as previously discussed, based on the peripheral device 104 printing contents of a file, the keyword module 220 extracts keywords from a text of the file and/or metadata associated with the file. In another example, as previously discussed, based on the peripheral device 104 scanning or copying a document, the keyword module 220 performs an optical character recognition (OCR) on the scanned/copied image to identify text included in the image. From the text included in the image, the keyword module 220 detects keywords associated with the image.

At 306, the peripheral device (e.g., the keyword module 220) transmits the keyword to a server (e.g., sever 120) over a network (e.g., network 116). For example, a keyword that has been recently detected by the peripheral device is transmitted to the server. In an embodiment, one more attributes of the peripheral device is also transmitted to the server. For example, a size of a display of the peripheral device is transmitted to the server, to enable the server to select an advertisement that can be effectively displayed in the display of the peripheral device.

At 308, in response to transmitting the keyword to the server over the network, the peripheral device (e.g., the advertisement reception module 224 of the peripheral device 104) receives an advertisement that is generated (e.g., by the server) based on the keyword.

At 310, the peripheral device (e.g., the advertisement providing module 228 of the peripheral device 104) provides the advertisement to a user of the peripheral device. In an example, providing the advertisements to the user of the peripheral device comprises displaying the advertisements on the display of the peripheral device, printing the advertisement by the peripheral device, transmitting the advertisements to a host device coupled to the peripheral device, and/or the like. In an embodiment, the provided advertisement is interactive in nature. That is, a user can interact with the advertisement (e.g., through a control panel of the peripheral device) to, for example, print the advertisement, request further information about a product associated with the advertisement, and/or the like.

In accordance with various embodiments, an article of manufacture may be provided that includes a storage medium having instructions stored thereon that, if executed, result in the operations described herein with respect to the method 300 (and/or various other operations discussed herein). In an embodiment, the storage medium comprises some type of non-transitory memory (e.g., memory 208). In accordance with various embodiments, the article of manufacture may be a computer-readable medium such as, for example, software or firmware.

The description incorporates use of the phrases “in an embodiment,” or “in various embodiments,” which may each refer to one or more of the same or different embodiments. Furthermore, the terms “comprising,” “including,” “having,” and the like, as used with respect to embodiments of the present disclosure, are synonymous.

Various operations may have been described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

Although specific embodiments have been illustrated and described herein, it is noted that a wide variety of alternate and/or equivalent implementations may be substituted for the specific embodiment shown and described without departing from the scope of the present disclosure. The present disclosure covers all methods, apparatus, and articles of manufacture fairly falling within the scope of the appended claims either literally or under the doctrine of equivalents. This application is intended to cover any adaptations or variations of the embodiment disclosed herein. Therefore, it is manifested and intended that the present disclosure be limited only by the claims and the equivalents thereof.

What is claimed is:

1. A method comprising:
performing, by a peripheral device, an image translation operation on an image;
in response to performing the image translation operation on the image, detecting, by the peripheral device, an attribute associated with the image;
transmitting, by the peripheral device, the attribute to a server over a network;
in response to transmitting the attribute to the server over the network, receiving, by the peripheral device, an advertisement that is generated based on the attribute; and
providing, by the peripheral device, the advertisement to a user of the peripheral device.

2. The method of claim 1, wherein providing the advertisement to the user of the image translation device comprises:
displaying the advertisement on a display surface of the peripheral device.

3. The method of claim 1, wherein providing the advertisement to the user of the image translation device comprises:
printing, by the peripheral device, the advertisement.

4. The method of claim 1, wherein providing the advertisement to the user of the image translation device comprises:
transmitting, by the peripheral device, the advertisement to a host device coupled to the peripheral device, to enable the host device to display the advertisement.

5. The method of claim 1, wherein detecting the attribute associated with the image comprises:
detecting a plurality of words from the image.

6. The method of claim 5, wherein detecting the plurality of words from the image further comprises:
performing an optical character recognition on the image to detect the plurality of words from the image.

7. The method of claim 1, wherein detecting the attribute associated with the image further comprises:
receiving metadata associated with the image; and
based on the metadata associated with the image, detecting the attribute associated with the image.

8. The method of claim 1, wherein providing the advertisement to the user of the peripheral device further comprises:
while the peripheral device is not engaged in active image translation operations, providing the advertisement to the user of the peripheral device.

9. The method of claim 1, further comprising:
in response to providing the advertisement to the user of the peripheral device, receiving, via a control panel of the peripheral device, a selection from the user of the peripheral device to one of (i) print at least a part of the advertisement and (ii) request further information about a product that is being advertised in the advertisement.

10. The method of claim 1, further comprising:
receiving revenue for providing the advertisement to the user of the peripheral device.

11. A peripheral device comprising:
an image translation module configured to perform an image translation operation on an image;
a keyword module configured to, in response to the image translation operation being performed on the image, (i) detect an attribute associated with the image and (ii) transmit the attribute to a server over a network;
an advertisement reception module configured to, in response to the attribute being transmitted to the server over the network, receive an advertisement that is generated based on the attribute; and
an advertisement providing module configured to provide the advertisement to a user of the peripheral device.

12. The peripheral device of claim 11, wherein the advertisement providing module is configured to provide the advertisement to the user of the peripheral device by:
displaying the advertisement on a display surface of the peripheral device.

13. The peripheral device of claim 11, wherein the advertisement providing module is configured to provide the advertisement to the user of the peripheral device by:
printing the advertisement.

14. The peripheral device of claim 11, wherein the advertisement providing module is configured to provide the advertisement to the user of the peripheral device by:
transmitting the advertisement to a host device coupled to the peripheral device, to enable the host device to display the advertisement.

15. The peripheral device of claim 11, wherein the keyword module is configured to detect the attribute associated with the image by:
detecting a plurality of words from the image.

16. The peripheral device of claim 15, wherein the keyword module is configured to detect the plurality of words from the image by:
performing an optical character recognition on the image to detect the plurality of words from the image.

17. The peripheral device of claim 11, wherein the keyword module is configured to detect the attribute associated with the image by:
receiving metadata associated with the image; and
based on the metadata associated with the image, detecting the attribute associated with the image.

18. The peripheral device of claim 11, wherein the advertisement providing module is configured to provide the advertisement to the user of the peripheral device by:
while the peripheral device is not engaged in active image translation operations, providing the advertisement to the user of the peripheral device.

19. The peripheral device of claim 11, wherein the advertisement providing module is further configured to:
in response to providing the advertisement to the user of the peripheral device, receive, via a control panel of the peripheral device, a selection from the user of the peripheral device to one of (i) print at least a part of the advertisement and (ii) request further information about a product that is being advertised in the advertisement.

20. The peripheral device of claim 11, wherein the peripheral device comprises one of (i) a printing device, (ii) a scanning device, (iii) a copying device, (iv) a faxing device, or (v) a multi-function printer.
